(19) United States
(12) Patent Application Publication
(10) Pub. No.: US 2017/0118127 A1
(43) Pub. Date: Apr. 27, 2017

(54) Systems and Methods of Virtualized Services

(71) Applicant: COX COMMUNICATIONS, INC., Atlanta, GA (US)

(72) Inventor: Jeff Finkelstein, Atlanta, GA (US)

(73) Assignee: COX COMMUNICATIONS, INC., Atlanta, GA (US)

(21) Appl. No.: 14/920,116

(22) Filed: Oct. 22, 2015

(51) Int. Cl. H04L 12/859; H04L 12/927; H04L 12/24; H04L 12/865

(52) U.S. Cl. CPC H04L 47/2475; H04L 47/6275; H04L 47/803; H04L 41/12

(57) ABSTRACT

The systems and methods of virtualized services disclosed herein use software defined networking (SDN), network functions virtualization (NFV), and tunnels as an encapsulation method to steer user originated and terminating traffic to and from a cloud network (virtual networks and devices) such that the data flows into the correct virtual and physical instances representative of user services. SDN may be used to maintain network topology and tomography which is used to calculate the correct path for data packets to reach the proper cloud or customer destination.

### TECHNICAL FIELD

The present disclosure is generally related to telecommunications and, more particularly, is related to cloud services.

### BACKGROUND

Cloud storage is a model of data storage in which digital data is stored in logical pools, the physical storage spans multiple servers (and often locations), and the physical environment is typically owned and managed by a hosting company. These cloud storage providers are responsible for maintaining the data as both available and accessible, and the physical environment as protected and running. Individuals and organizations buy or lease storage capacity from the providers to store user, organization, or application data.

Cloud storage services may be accessed through a co-located cloud computer service, a web service application programming interface (API) or by applications that utilize the API, such as cloud desktop storage, a cloud storage gateway or Web-based content management systems. Cloud storage may be based on highly virtualized infrastructure in terms of accessible interfaces, near-instant elasticity and scalability, multi-tenancy, and metered resources. Cloud storage services may be utilized from an off-premises service or deployed on-premises.

Cloud storage typically refers to a hosted object storage service, but the term has broadened to include other types of data storage that are now available as a service, such as block storage. Cloud storage may comprise many distributed resources, but still act as one resource—often referred to as federated storage clouds. It is highly fault tolerant through redundancy and distribution of data. It is highly durable through the creation of versioned copies and is typically eventually consistent with regard to data replicas.

Cloud computing allows application software to be operated using internet-enabled devices. Clouds may be classified as public, private, and hybrid. Cloud computing relies on sharing of resources to achieve coherence and economies of scale over a network. At the foundation of cloud computing is the broader concept of converged infrastructure and shared services.

Cloud computing, or in simpler shorthand just “the cloud”, also focuses on maximizing the effectiveness of the shared resources. Cloud resources are usually not only shared by multiple users but are also dynamically reallocated per demand. This may improve the allocating of resources to users. For example, a cloud computer facility that serves European users during European business hours with a specific application (e.g., email) may reallocate the same resources to serve North American users during North America's business hours with a different application (e.g., a web server). This approach should maximize the use of computing power, thus reducing environmental damage as well since less power, air conditioning, rack space, etc. are required for a variety of functions. With cloud computing, multiple users can access a single server to retrieve and update their data without purchasing licenses for different applications.

Cloud computing allows companies to avoid upfront infrastructure costs, and focus on projects that differentiate their businesses instead of on infrastructure. Cloud computing also allows enterprises to get their applications up and running faster with improved manageability and less maintenance, and enables IT to more rapidly adjust resources to meet fluctuating and unpredictable business demand. Cloud providers typically use a “pay as you go” model.

The present availability of high-capacity networks, low-cost computers and storage devices as well as the widespread adoption of hardware virtualization, service-oriented architecture, and autonomic and utility computing have led to a growth in cloud computing. Companies can scale up as computing needs increase and then scale down again as demands decrease.

From a service provider perspective, instead of putting hardware in the customer premises, the software and the hardware may be moved into the cloud. This eliminates equipment maintenance in the customer home or premises. If the software or hardware needs updating, then it is all done in the cloud. Traditionally, the service provider would install hardware into the customer premises by sending a technician in a truck to connect it, which is a costly process both in time and finances. As more functionality is relocated into the cloud, virtual services may be implemented. However, now the cloud environment is created with a complex ecosystem in which a data stream or an IP flow, for example, is transmitted from the customer premises and statically directed to a virtual machine in the cloud. Anytime the customer moves from one access point to another, another mechanism is statically created to direct that traffic from the customer to the cloud-based application. The typical topology is not maintainable with millions of millions of users in moving applications in the cloud. There are heretofore unaddressed needs with previous cloud computing solutions.

### SUMMARY

Example embodiments of the present disclosure provide systems of virtualized services. Briefly described, in architecture, one example embodiment of the system, among others, can be implemented as follows: a tunnel aggregator located in a cloud computing environment, the tunnel aggregator configured to: receive information regarding a customer premises device and a request for upstream or downstream traffic content; and provide a virtual customer network (VON) in the cloud computing environment to direct the upstream or downstream traffic, the upstream or downstream traffic tunneled from the customer premises device and through the VCN before sending/receiving the traffic content to/from a destination/source.

Embodiments of the present disclosure can also be viewed as providing methods for virtualized services. In this regard, one embodiment of such a method, among others, can be broadly summarized by the following steps: receiving, by a tunnel aggregator located in a cloud computing environment, a request for upstream or downstream traffic content, the request including information identifying a customer premises device requesting the upstream or downstream traffic; providing a virtual customer network (VCN) in the cloud computing environment to direct the upstream or downstream traffic; and tunneling the upstream or downstream traffic through the VCN before sending/receiving the downstream/upstream traffic content to/from a destination/source.

### BRIEF DESCRIPTION OF THE DRAWINGS

FIG. 1 is a system block diagram of an example embodiment of a customer premises.

FIG. 2 is a system block diagram of an example embodiment of a system of virtualized services.

FIG. 3 is a system block diagram of an example embodiment of the system of FIG. 3 with virtual customer networks.

FIG. 4 is a flow diagram of an example embodiment of a method of virtualized services.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Disclosed herein are example embodiments of the systems and methods of virtualized services using software defined networking (SDN), network functions virtualization (NFV), and tunnels as an encapsulation method to steer user originated and terminating traffic to and from a cloud network (virtual networks and devices) such that the data flows into the correct virtual and physical instances representative of user services. SDN may be used to maintain network topology and tomography which is used to calculate the correct path for data packets to reach the proper cloud or customer destination. NFV may be used to manage the virtual machines and create new instances as appropriate. Tunnels (such as SoftGRE, L2TP, L2VPN, L3VPN, IPSEC, or VLAN) may be used to direct the traffic flows to and from the customer premise equipment.

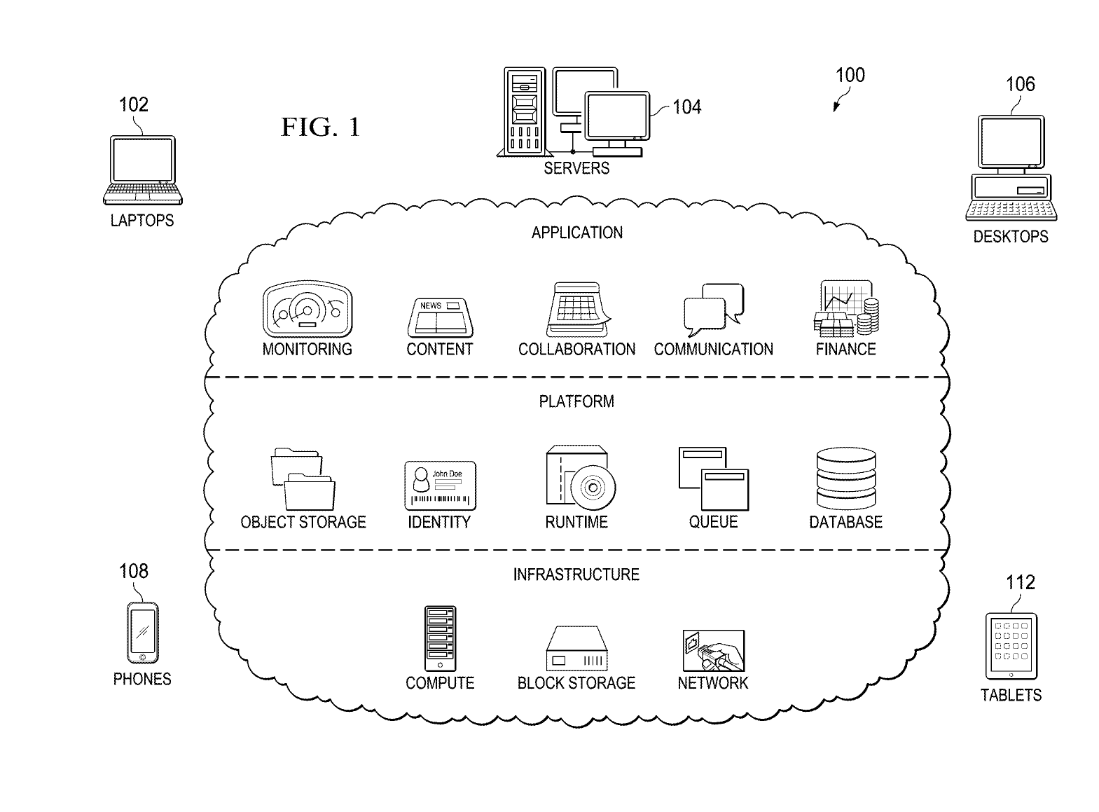

In any customer premises, there may be a number of devices that connect to the internet. Example embodiments of the systems and methods of virtualized services disclosed herein may implement a software-defined network to communicate through the cloud. Referring to FIG. 1, there may different networks inside customer premises 100—network 1, network 2, network 3, network 4, etc.—and they may be wired, wireless, and even cellular. Devices such as laptops 102, servers 104, desktops 106, phones 108 and tablets 112 (among other devices) may be connected to any of these networks in customer premises 100. Each separate network with its own SSID may use software based tunnels such as SoftGRE, L2TP, L2VPN, L3VPN, IPSEC, VLANs, among others, to route traffic into the cloud. In example embodiments, that traffic is encapsulated and sent as layer-2 traffic up to the cloud.

Traditionally, a gateway in the customer premises performs network address translation. The gateway re-writes the header for the traffic and replaces an RFC 1918 station with a globally routable IP address, which is assigned when a device is connected to an LNT, cable modem, or DSL modem among others. The globally routable IP address may be considered as a globally unique identifier (GUID). The GUID is trackable so that return transmissions can determine a correct return destination point. All the traffic within the customer premises (the layer-2 traffic in which the MAC address and the IP address is available) has traditionally been hidden behind the gateway device.

If any of the traffic is not accessible, it cannot be managed. To allow access to the layer-2 traffic, the service provider may offer a service of managing the home network. To access the layer-2 traffic, the service provider may extend the home network into the cloud, enabling access to all of the traffic in the cloud. There may still be some traffic that remains inaccessible. For example, one device communicating with another device in the house does not necessarily have to route out to the cloud. However, anything that is not recognized as intra-premises traffic may be sent up to the cloud. In an example embodiment, the traffic is sent through a tunnel aggregator, which excludes the access network. The nature of the content is unimportant because there are no access network specific protocols to be concerned with.

As the traffic passes through the tunnels and the layer-2 traffic is visible, the traffic may be scheduled multi-dimensionally. The flows may be identified as well as the applications that send the traffic in those flows and the devices that run those applications. This multi-dimensional view may be managed at a much more granular level. The information about the traffic changes the way the customer presence is viewed, whether it is residential or commercial. A hierarchical cluster may be implemented in which layers upon layers are monitored and the devices, the applications, and even the subscribers on those devices may be managed. A multi-layer view is produced to monitor the traffic in the network, allowing the tunnels to be extended from the network into the cloud.

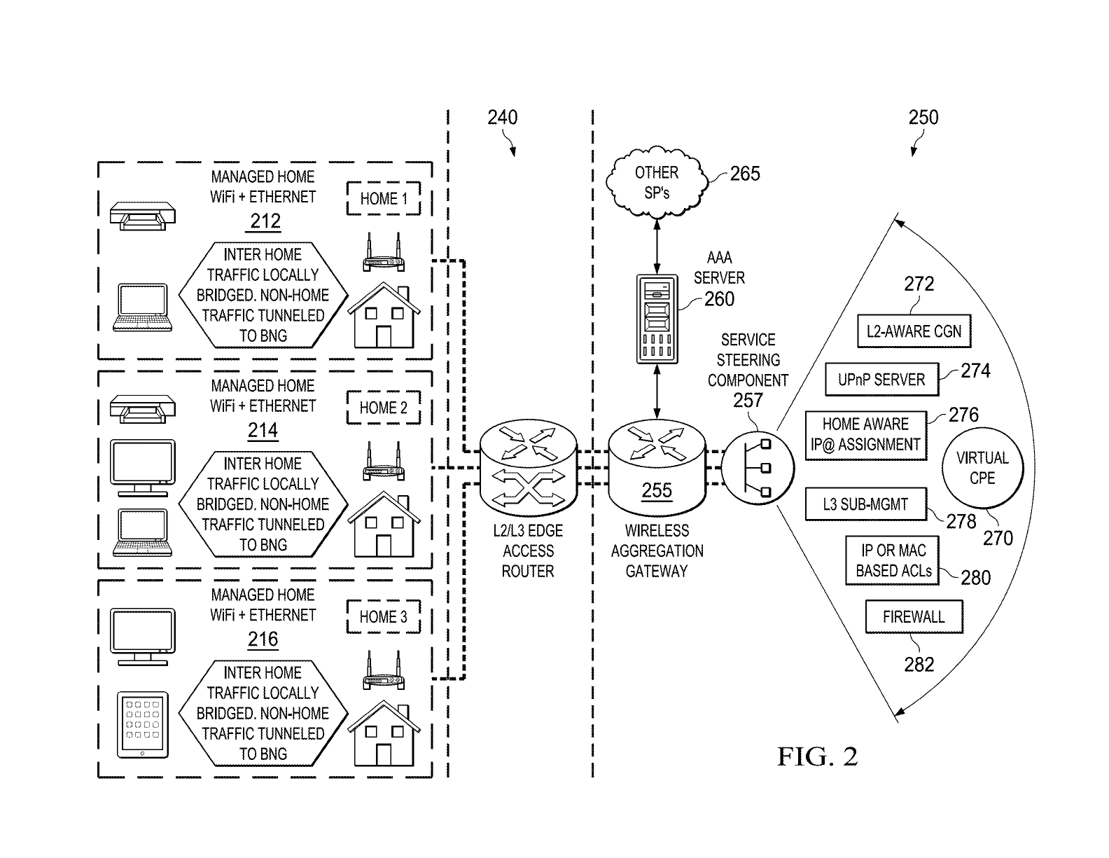

In an example implementation, the service provider can monitor the traffic from each device and from each user. Each user logs in and the MAC address for that user is authenticated. Traffic from each device and each user can be differentiated, such as parents with a 4K TV in the living room, children with a 1K television in their bedrooms, each laptop, each smart phone, all running different applications. In an example embodiment provided in FIG. 2, traffic from customer premises 212, 214, and 216 travels through edge access router 240 of the network into a wireless or tunnel aggregator 255, such as a wireless aggregation gateway (WAG) or a tunnel aggregation gateway (TAG), or a wireless line concentrator, for example, located in cloud 250. As the data enters tunnel aggregator 255, tunnel aggregator accesses the Authentication Authorization Accounting (AAA) information about the user/user profile provided by AAA server 260.

This user profile may contain not just the username and password, but also the devices the user is authorized to log into, the bandwidth that the user is allocated on the different devices, and the applications that the user is authorized to use, as well as other data that may be entered into the profile. This user profile may be shared with all the devices within the subscriber network. Tunnel aggregator 255, then, may receive information about the traffic from the user and that the user is using an application or a device that, for example, she may not be authorized to use. Tunnel aggregator 255 may send the device traffic to a “walled garden” or may refuse connectivity. Alternatively, tunnel aggregator 255 may communicate with a TR-069-type system (TR-069 (Technical Report 069) is a technical specification that defines an application layer protocol for remote management of end-user devices) for managing the in-home devices and request that the TR-069-type system shut off the device or, perhaps, a community Wi-Fi. For the allowable services, though, tunnel aggregator 255 may send the traffic content to service steering component 257. Tunnel aggregator 255 has awareness of the customer premises traffic on the left hand side of tunnel aggregator 255 and of cloud 250 on the right hand side of tunnel aggregator 255.

In an example embodiment, tunnel aggregator 255 may use a hierarchical cluster representation and service steering component 257 to manage the flows, the applications, the tunnels, and the applications within the tunnels in multi-layers. Service steering component 257 may be a software component that may be part of the tunnel aggregator, may be a separate hardware element, or may be a cloud based service, among other implementations. Any aspect pertaining to a particular SSID may be managed. Services that may be managed by tunnel aggregator 255 in cloud 250 include non-limiting examples of virtual CPE 270, L2-aware CGN 272, UPnP server 274, home aware IP@ assignment 276, L3 sub-management 278, IP or MAC based ACLs 280, and firewall 282. For example, to ensure that a 4K TV has sufficient bandwidth to provide a good viewing experience (for example, 4K TV needs 10 milliseconds of latency), tunnel aggregator 255 may prioritize the 4K TV traffic over other traffic in the multi-layer flow. The hierarchical cluster provides a view for management of the in-home network traffic.

Since tunnel aggregator 255 has awareness of the home traffic, authentications, access levels, and bandwidth requirements, among other example factors, and tunnel aggregator 255 sends the traffic through service steering component 257, service steering component 257 now has awareness of the traffic properties coming from tunnel aggregator 255. Service steering component 257 has awareness of, as non-limiting examples, the origination of the traffic, the application generating the traffic, the device identifier, the subscriber identifier, and the physical location by using, for example, Location Identifier Separation Protocol (LISP).

With the information awareness of the user, functions such as targeted advertising are enabled. With example embodiments of the systems and methods of virtualized services disclosed herein, the system may, in an example implementation, recognize that a child is using a device someplace that he is not supposed to be, and the system may block the access if the parent has configured the access restrictions. As another example, in a school environment, when the school traffic enters the tunnel during a school day, a student may be allowed to go to the classroom site (the system is aware that he is in the classroom from the SSID) or other allowed sites, but not, for example, to Facebook or other restricted sites.

In an example embodiment of the systems and methods of virtualized services disclosed herein, a smart phone may be configured to use a hard-coded tunnel that passes traffic back to tunnel aggregator 255. Even if a user is traveling with the smart phone, the traffic may still be passed back to tunnel aggregator 255. If a child uses a smart phone with tunnel aggregation software installed, regardless of whether the phone is connected to a Wi-Fi network or a cellular network, the traffic is still passed to tunnel aggregator 255 and the user is still under the parental controls that are designated in the user profile. All traffic through any device may be routed through tunnel aggregator 255 in a cloud service in the service provider network.

Depending on the authorization level, tunnel aggregator 255 may only route specific traffic. The authorization of a particular device or user may be reserved to the administrator of the account. The administrator may set the authorization levels. For example, if a user is in New York, all the traffic may be routed through tunnel aggregator 255, or, alternatively, only a certain part of the traffic may be routed through tunnel aggregator 255. If a user accesses video content stored in the cloud, the video content may be routed through tunnel aggregator 255 but the internet traffic may be sent on a different path, avoiding tunnel aggregator 255.

Traffic information is available through tunnel aggregator 255 on many levels. Server steering component 257 has access to the traffic origination point. Server steering component 257 has access to the origination location and to the traffic in the cloud. Therefore, server steering component 257 may select an appropriate application if an issue occurs on the network or a segment of the network is out of service. Cloud 250 may use this information to relocate virtual machines from Atlanta to San Diego, steering the traffic to San Diego automatically because it has awareness of the cloud traffic information, as notified by the software defined network (SDN).

In an example embodiment, tunnel aggregator 255 communicates that information down through the SDN to the service steering component. Tunnel aggregator 255 not only has an awareness of the traffic in the cloud, but it has awareness of the utilization of the traffic in the cloud. Tunnel aggregator 255 may have information that a segment of the cloud has heavy network traffic or very high utilization, and send the traffic elsewhere without any intervention involved. Tunnel aggregator 255 may also communicate information pertaining to traffic inside the cloud.

For example, if a customer changes location from home on one side of the city to an office on the other side of the city, and there is a cloud or a portion of the cloud that is closer to the customer, tunnel aggregator 255 may transfer the customer traffic to that part of the cloud. A user may configure one or more rules including, as non-limiting examples, time-based access, parental controls, web site filtering, email scanning, web page scanning for malware, and redirection of traffic, among others. If traffic flows or requests are exceeding the available bandwidth, tunnel aggregator 255 may throttle traffic or re-route traffic elsewhere. Primary control program (PCP) optimizations may be performed to acknowledge requests to improve traffic throughput as well as to buffer traffic to provide the traffic content to the user at a steady rate.

Authentication may be performed by tunnel aggregator 255 by communicating with AAA server 260 that is part of the subscriber network. AAA server 260 may also be accessed by other service providers 265. A TR-069 server may be used to manage all of the devices. The TR-069 server may reside in the customer premises network in communication with AAA server 260. The TR-069 server and AAA server 260 may connect to tunnel aggregator 255 and to server steering component 257 in cloud 250.

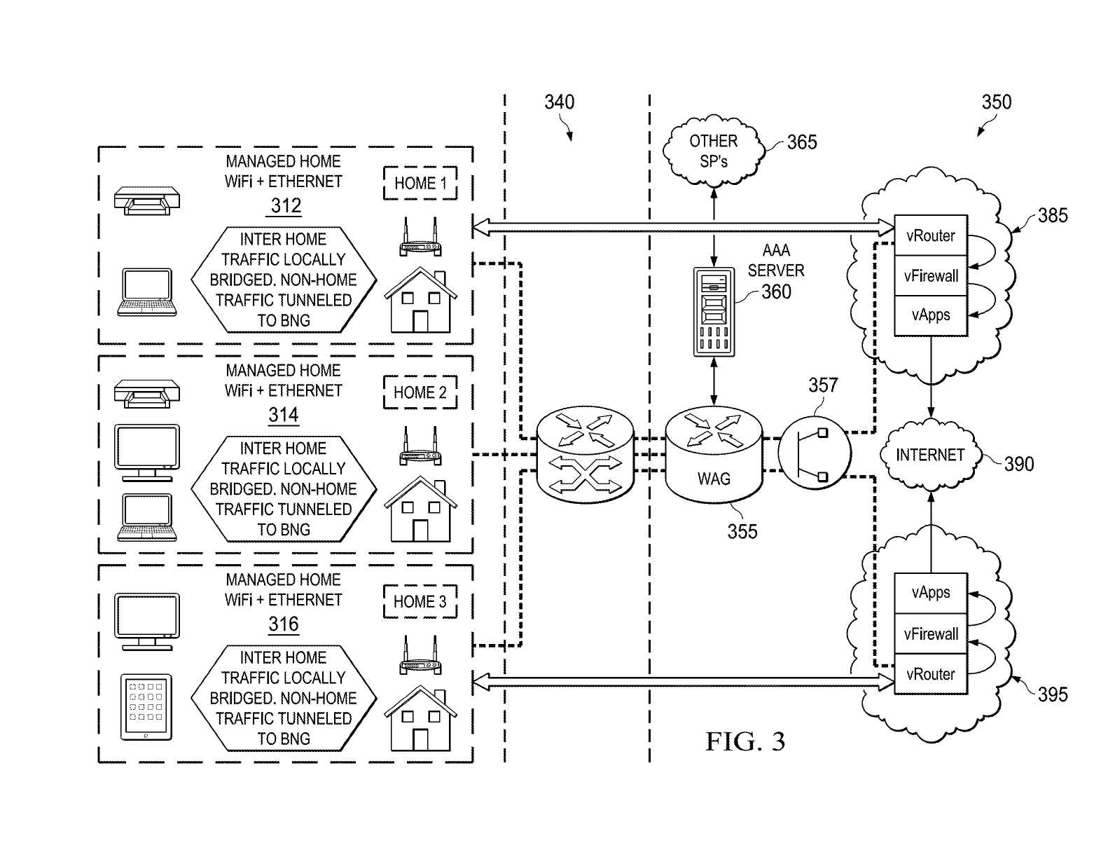

FIG. 3 provides an example embodiment of the systems and methods of virtualized services with tunnel aggregator 355 managing per customer virtual networks 385, 395 through service steering component 357 in cloud 350. Service steering component 357 may be a software component that may be part of the tunnel aggregator, may be a separate hardware element, or may be a cloud based service, among other implementations. Traffic from customer premises 312, 314, and 316 travels through edge access router 340 of the network into a tunnel aggregator 355 located in cloud 350. As the data enters tunnel aggregator 355, tunnel aggregator accesses the AAA information about the user/user profile provided by AAA server 360. AAA server 360 may be accessed by other service providers 365. Virtual networks 385, 395 may be connected to internet 390. In an example embodiment, virtual network 385 is set up for customer premises 312 to embody services, such as a virtual router, a virtual firewall, and virtual applications, all provided and managed in cloud 350. Similarly, virtual network 395 is provided for customer premises 316.

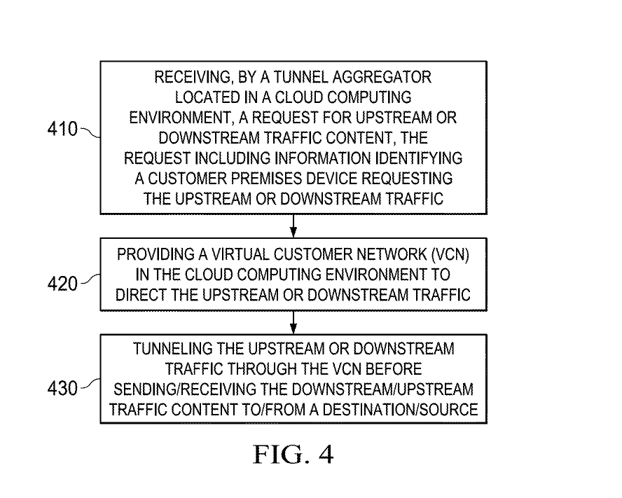

FIG. 4 provides a flow diagram of an example embodiment of a method of virtualized services. In block 410, a request for upstream or downstream traffic content is received by a tunnel aggregator located in a cloud computing environment, the request including information identifying a customer premises device requesting the upstream or downstream traffic. In block 420, a virtual customer network (VCN) is provided in the cloud computing environment to direct the upstream or downstream traffic. In block 430, the upstream or downstream traffic is tunneled through the VCN before sending/receiving the downstream/upstream traffic content to/from a destination/source.

The informational/traffic awareness throughout the network, as offered by example embodiments of the systems and methods of virtualized services disclosed herein, provide the ability to control throughput and routing at a higher level than before. Valuated services may be layered on the traffic. Non-limiting examples of valuated services include parental controls, home security with video capability, home automation, and in-premises device management, among others. If a Mac user, for example, uses the Time Machine application for back-up purposes, each user plugs a hardware device into a master device one at a time, or the device may be attached through the home Wi-Fi network. If the Time Machine application is located in the cloud, accessible by the tunnel aggregator, the application may back up the devices automatically, regardless of the device location because the device is being tunneled back into the user's network by the tunnel aggregator. Cloud-stored video content may be provided location-independent without latency issues.

Service providers may currently provide a similar function with their cloud-based storage offerings, but the user is restricted by the service provider's requiring the user to only be connected on that service provider's network. With an example embodiment of the system disclosed herein, access may be offered regardless of the network that the user is connected to. Example embodiments of the systems disclosed herein are unique in that the tunnel aggregator, with knowledge of the user and network traffic information, may route and manage that traffic based upon the AAA and the unique profile for the user. Steering that traffic based on pre-defined criteria is unique. Using software-defined networking to determine the state of the network and the state of what the customer is doing is unique. Awareness of cloud bandwidth and redirecting user traffic to a closer cloud network based on device location is also unique.

Example embodiments of the systems and methods of virtualized services provided herein allow for roaming across boundaries with access to the cloud. The administration portal is moved to the cloud to reduce calls for the SSID/key. More data is available to troubleshoot in-premises devices. Private/public Wi-Fi is provided in multi-access point environments using existing platform components. Multiple SSID and branded secure Wi-Fi is provided for employees, guests, and the public. Per-user profiles are provided with no software loaded on the client. Local bridging is provided for file sharing, data backup services, and printing.

The flow chart of FIG. 4 shows the architecture, functionality, and operation of a possible implementation of the virtualized services software. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
a tunnel aggregator located in a cloud computing environment, the tunnel aggregator configured to:
receive information regarding a customer premises device and a request for upstream or downstream traffic content; and
provide a virtual customer network (VON) in the cloud computing environment to direct the upstream or downstream traffic, the upstream or downstream traffic tunneled from the customer premises device and through the VCN before sending/receiving the traffic content to/from a destination/source.

2. The system of claim 1, wherein the tunnel aggregator is further configured to access an authentication, authorization, accounting (AAA) server located in the cloud computing environment to determine authorization of a user on the customer premises device.

3. The system of claim 1, wherein the tunnel aggregator is further configured to access an authentication, authorization, accounting (AAA) server located in the cloud computing environment to determine authorization of the traffic content for a user on the customer premises device.

4. The system of claim 1, wherein the tunnel aggregator is further configured to access a user profile from an authentication, authorization, accounting (AAA) server located in the cloud computing, the user profile comprising at least one of a user ID, password, authorized devices for the user, bandwidth the user is allocated on the customer premises device, and authorized applications for the user.

5. The system of claim 1, wherein the tunnel aggregator uses software defined networking (SDN) and network functions virtualization (NFV) to steer the upstream or downstream traffic content into appropriate virtual and physical instances representative of user services.

6. The system of claim 5, wherein the SDN is used to maintain network topology and tomography to calculate an appropriate path for the traffic content to reach an appropriate destination.

7. The system of claim 5, wherein the NFV is used to manage the virtual instances and create new virtual instances.

8. The system of claim 1, wherein traffic content from the customer premises device is encapsulated and received by the tunnel aggregator as layer-2 traffic.

9. The system of claim 1, wherein the tunnel aggregator schedules traffic multi-dimensionally by traffic flows, applications that send traffic in the flows, and devices that run the applications.

10. A method, comprising:
receiving, by a tunnel aggregator located in a cloud computing environment, a request for upstream or downstream traffic content, the request including information identifying a customer premises device requesting the upstream or downstream traffic;
providing a virtual customer network (VCN) in the cloud computing environment to direct the upstream or downstream traffic; and
tunneling the upstream or downstream traffic through the VCN before sending/receiving the downstream/upstream traffic content to/from a destination/source.

11. The method of claim 10, further comprising accessing, by the tunnel aggregator, an authentication, authorization, accounting (AAA) server located in the cloud computing environment to determine authorization of a user on the customer premises device.

12. The method of claim 10, further comprising accessing, by the tunnel aggregator, an authentication, authorization, accounting (AAA) server located in the cloud computing environment to determine authorization of the traffic content for a user on the customer premises device.

13. The method of claim 10, further comprising accessing, by the tunnel aggregator, a user profile on an authentication, authorization, accounting (AAA) server located in the cloud computing environment, the user profile comprising at least one of a user name password, authorized devices for the user, bandwidth the user is allocated on the customer premises device, and authorized applications for the user.

14. The method of claim 10, further comprising steering the upstream and downstream traffic content into appropriate virtual and physical instances representative of user services, the steering performed with software defined networking (SDN) and network functions virtualization (NFV).

15. The method of claim 14, further comprising maintaining, by the SDN, network topology and tomography to calculate an appropriate path for the traffic content to reach an appropriate destination.

16. The system of claim 14, further comprising managing the virtual instances by the NFV and creating new virtual instances by the NFV.

17. The system of claim 10, further comprising encapsulating traffic content from the customer premises device by the tunnel aggregator and receiving the encapsulating the traffic content as layer-2 traffic.

18. The system of claim 10, further comprising multi-dimensionally scheduling traffic, by the tunnel aggregator, the scheduling performed according to traffic flows, applications that send traffic in the flows, and devices that run the applications.

19. A tangible computer readable medium comprising software with instructions for:
receiving, by a tunnel aggregator located in a cloud computing environment, a request for upstream or downstream traffic content, the request including information identifying a customer premises device requesting the upstream or downstream traffic;
providing a virtual customer network (VCN) in the cloud computing environment to direct the upstream or downstream traffic; and
tunneling the upstream or downstream traffic through the VCN before sending/receiving the downstream/upstream traffic content to/from a destination/source

20. The computer readable medium of claim 19, further comprising instructions for steering the upstream and downstream traffic content into appropriate virtual and physical instances representative of user services, the steering performed with software defined networking (SDN) and network functions virtualization (NFV).
